(19) United States
(12) Patent Application Publication
(10) Pub. No.: US 2006/0013132 A1
(43) Pub. Date: Jan. 19, 2006

(54) Nonlinear adaptive control of resource-distribution dynamics

(75) Inventors: James G. Garnett, Longmont, CO (US); Elizabeth Bradley, Boulder, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Regents of the University of Colorado, Boulder, CO (US)

(21) Appl. No.: 11/155,535

(22) Filed: Jun. 16, 2005

Related U.S. Application Data
(60) Provisional application No. 60/580,484, filed on Jun. 16, 2004.

(51) Int. Cl. G01R 31/08

(52) U.S. Cl. 370/229

(57) ABSTRACT

Nonlinear adaptive resource management systems and methods are provided. According to one embodiment, a controller identifies and prevents resource starvation in resource-limited systems. To function correctly, system processes require resources that can be exhausted when under high load conditions. If the load conditions continue a complete system failure may occur. Controllers functioning in accordance with embodiments of the present invention avoid these failures by distribution shaping that completely avoids undesirable states. According to one embodiment, a Markov Birth/Death Chain model of the resource usage is built based on the structure of the system, with the number of states determined by the amount of resources, and the transition probabilities by the instantaneous rates of observed consumption and release. A control stage is used to guide a controller that denies some resource requests in real systems in a principled manner, thereby reducing the demand rate and the resulting distribution of resource states.

### CROSS-REFERENCE TO RELATED APPLICATIONS

This application claims the benefit of Provisional Application No. 60/580,484, filed on Jun. 16, 2004, which is hereby incorporated by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD

Embodiments of the present invention generally relate to systems and methods for controlling access to system resources. More specifically, embodiments of the present invention relate to controlling the full distribution of resource states in resource-limited systems by using an adaptive, nonlinear, model-reference controller in order to prevent failures that result from high demand on limited resources in software systems and the like.

### BACKGROUND

Description of the Related Art

Resources such as memory, bandwidth, and CPU cycles are the central nervous system of information technology, but their shared nature can make them single points of failure. A router that is overwhelmed by requests, for instance, can bring down an entire computer network. Similarly, a central switching controller that is overloaded with sensor data can bring a city's subway system to a halt; and an over-committed memory buffer pool can deadlock communicating processes on a single machine. Failures such as these, and others, are often the result of too many software processes competing for too few resources, e.g., buffer space, resulting in resource starvation and system failure.

Traditional fault tolerance methods typically seek to address these single-point-of-failure problems by replicating resources in space or time, e.g., multiple web-servers or routers, redundantly connected networks, vast amounts of buffer memory, protocols that retransmit, etc. These kinds of over engineering and redundancy are not universal solutions in the modern networked world. For example, in the Internet, where the volume of denial of service attacks appears to be increasing exponentially, such an approach is simply not feasible.

Current design philosophies also contribute to problematic behavior. For example, the so-called “best effort” strategy, in which arriving network requests are serviced as soon as possible, as long as resources are available, can lead to resource saturation. That is, once all resources, such as network buffers, are in use, every new request will be dropped. This kind of all-or-nothing approach gives rise to some fairly wrenching dynamics: perfect service up to a point, and then complete failure.

In addition, variables derived from Gaussian statistics, such as the average number of resources in use, have been historically used to smooth burstiness and generally help facilitate controller stability. However, these statistics may not adequately represent the true system state. As a result, minute changes in the operating environment can result in abrupt system failures.

Thus, a need exists in the art for more advanced control systems which are capable of controlling the full distribution of resource states to improve the stability and security of resource-limited systems by reducing starvation side effects of shared resources.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an example of a computer system with which embodiments of the present invention may be utilized;

FIG. 2 conceptually illustrates a dual interface communications system in which embodiments of the present invention may be employed;

FIG. 3 illustrates a graph-theoretic representation of an exemplary Birth/Death Markov Chan that may be used in accordance with one embodiment of the present invention;

FIG. 4 is a high level block diagram of a control system structure according to one embodiment of the present invention;

FIG. 5 is a detailed block diagram of a nonlinear adaptive control system structure that may be used in accordance with one embodiment of the present invention;

FIGS. 6a-6c illustrate possible distributions in relation to a QoS control specification which may be found in embodiments of the present invention;

FIG. 7 is a high level block diagram of a nonlinear adaptive controller that may be used in accordance with one embodiment of the present invention;

FIG. 8 illustrates a quasi-stable convergence of an exemplary system;

FIG. 9 is high level flow chart describing exemplary operations in one embodiment of a resource request admission process;

FIG. 10 is a high level flow chart describing exemplary operations for computing request probability denial in accordance with one embodiment; and

FIG. 11 is a detailed flow chart describing one embodiment of a resource request admission process.

### SUMMARY

Nonlinear adaptive resource management systems and methods are described. According to one embodiment, a set of principled control-theoretic methods are combined with probabilistic modeling techniques to allow distributed software and hardware networks to avoid saturation-induced failures. The controller that embodies these solutions is designed to:
model the dynamic state of each resource in a shared network using stochastic methods;
identify dangerous regimes; and
selectively control access to resources through nonlinear service degradation.

This model-based control scheme employs on-line parameter estimation to measure changing network parameters, allowing it to react in a meaningful way to dynamically varying loads and system conditions. Adaptivity not only improves controller performance; it is particularly important for autonomous applications, where a controller may have to refit itself without human intervention e.g., because it is on the far side of a planet and out of radio control.

According to another embodiment, the controller uses a nonlinear transform to precondition the measured error signal.

According to yet another embodiment, the behavior of a resource network is described via a resource usage distribution—that is, a measure of the percentage of time a given amount of resources is in use. Usage distributions are not only effective ways to describe behavior, but also useful targets for control: one simply expresses the control goal by defining explicit limits on how much time may be spent in ‘bad’ regimes. Rather than working directly with distributions, however, embodiments of the present invention first build a distribution model, such as a stochastic Markov Chain model, a directed graph that captures even finer-grained information about how congestion ebbs and flows in the network nodes. Controllers that use the type of detailed information provided by a Markov Chain model are far more powerful and precise than controllers that take action based only on aggregate measures like Gaussian statistics (e.g., means and standard deviations). Moreover, Markov Chain models can capture not only the dynamics of specific systems, but general behaviors of entire families of systems, which makes these methods broadly applicable.

Other features of embodiments of the present invention will be apparent from the accompanying drawings and from the detailed description that follows.

### DETAILED DESCRIPTION

Nonlinear adaptive resource management systems and methods are described. Broadly stated, embodiments of the present invention seek to facilitate the development of reliable systems with predictable behavior. According to one embodiment, an adaptive, nonlinear, model-reference controller seeks to prevent failures that result from high demand on limited resources, in software systems, for example, by building a model of resource usage and subsequently reducing demand on resources by selectively denying resource requests based upon the model. In this manner, service may be degraded smoothly, in a controlled and principled fashion before the situation becomes dire.

According to one embodiment, a controller shapes the probability distribution of resource states such that the likelihood of entering a failure regime is zero. This is a fundamental departure from current practices, which rely on Gaussian statistics that collapse the dynamics of the distribution into aggregate metrics (averages and variances).

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to a specific distribution model, i.e., the Markov Birth/Death Chain model, the present invention is equally applicable to various other current and future distribution models. Similarly, the number of states in the Chain may be determined other than with reference to the number of resources as described.

Additionally, while embodiments of the present invention are described in the context of network-traffic queuing, the approach is much more widely applicable. For example, the techniques and methodologies described herein are generally applicable to general purpose or embedded computer operating systems. Embedded systems are those that perform a specific purpose, such as the engine control systems in modern automobiles, the packet routing software in network routers, call management software in telecommunications switches and others. General-purpose operating systems are the nonembedded applications that are commonly associated with the idea of ‘computing,’ e.g. home and business computer operating systems such as Windows, Linux, Solaris, and AIX, as well as scientific supercomputer operating systems.

An advantage of the methods and techniques described herein stems from the robustness that they can provide to the user of the system in the face of traditionally failure-causing scenarios, e.g., malicious attacks. A home computer user might experience an Internet Denial of Service attack that would crash the computer; with the protection of the resource management scheme described herein, that user would be able to continue to work—albeit with degraded functionality. Consequently, the methods therefore also have the potential to mitigate the effects of Internet-borne computer viruses.

Another example includes TCP/IP Network routers. Network routers are switches that accept incoming traffic on one network and then reroute that traffic to an appropriate destination network. Each incoming packet consumes some memory resources on the router. If there are too many incoming packets, then the memory resources will be completely exhausted. This will result in an abrupt halt to all packet routing. If the router is a hub for many networks, then this can completely cripple a great many network communications. It is often the case that excessive traffic appears on only a small set of the networks, such as in the case of a so-called Denial of Service (DoS) attack. The controller could, in this case, squelch the excessive traffic on those few networks, and thereby allow communications to continue on the remaining networks.

Operating System Kernel tables are another example of possible applications. Modern operating systems such as Linux, Windows XP, MacOS, etc. use fixed tables to manage software. For example, when a user opens the “Mozilla” browser under Linux or “Microsoft Word” under Windows XP, those programs (called processes and threads) are assigned one or more Process IDs (PIDs). Each PID is an index into the process table, which contains state information for every running program. The size of the process table is fixed, so there is a limit on the number of programs that may be run at once. Once the table fills, the result is usually an apparently ‘hung’ machine, and the user is forced to reboot.

The controller could manage the process table so that only certain predetermined programs can be run once the table begins to fill, such as the task manager (to clean up), or automatic cleanup programs, etc. This would prevent the reboot and allow for automatic, graceful recoveries. Note that this is not necessarily a local problem: a remote attacker on a network can fill the process table. For example, a WWW server usually creates a copy of itself for every new network connection. When someone views a web page, the remote server copies itself, thereby using a PID slot in the remote process table. If more users simultaneously view the web-page than PID slots in the table, the remote server may become hung.

Other embodiments of the techniques and methodologies are applicable to virtual memory (VM) systems. Memory in modem operating systems is managed in chunks called virtual memory pages whose number is finite and which can exist either in semiconductor RAM or on disk. A cheap way to add more memory to a computer system, then, is to add a bigger disk. Disks are prone to hardware failure, however, and a sudden disk failure is the same as a sudden loss of memory at the operating system level. In this situation, the operating system must shed some of its load by stopping some software from running, and it must also prevent low-priority programs from starting, or else the entire system could crash. At present there is no way to do this, but a resource controller in the operating system's Virtual Memory subsystem could do this automatically by allowing predefined high-priority programs to run, while denying memory (and hence the ability to run) to low-priority programs. Such a high-priority program might be one that alerts a human to the disk failure, so the controller would allow the system to function at a reduced level of service while at the same time automatically alerting the system administrator to the problem.

Server software is vulnerable to saturation and overload by connections from remote clients. In the operating system kernel tables, for examples a scenario may exist in which too many clients are connected to a WWW server and cause it to fill the process table, as well as a controller in the operating system that could prevent the table from filling. This controller could be put into the WWW server itself, as well, and allow the WWW server to manage its own replication behavior and enable it to prevent itself (and its spawned copies) from filling the process table. This is a finer-grained approach than putting the controller on the process table itself: it allows every server program on a machine to manage its own PID-table-slot consumption. Other servers that would benefit from this approach:
Email servers (SMTP, Lotus Notes, POP, IMAP, etc.)
Domain Name Service servers (DNS)
Network Filesystem Servers (NFS)
Microsoft filesystem servers (GIFS)
SAMBA (Microsoft-to-unix filesystem servers)
Microsoft Domain Controllers
Directory Service (LDAP/411) servers
Database servers
Microsoft's online patching service

This is a minimal list, and a more complete list might go on for many pages. In general, any type of ‘server’ that handles connections from ‘clients’ could benefit from this technology.

Note that operating-system-level implementations of the resource controller (e.g., the process-table-level controller) are still useful, since the servers listed above can be 3rd-party software and therefore may not be guaranteed to have a controller built into them. In that case, the operating system would still benefit from its own controller in order to prevent runaway servers.

Yet other possible applications include telephone switches. The telephone system is a finite network of switches and communications lines that can be overwhelmed when too many calls are placed. Telephone calls consume a fixed amount of resources that are reserved when the calls are placed, and that remain in use until the calls are completed. An overload of calls results in a situation in which “all circuits are busy.”

These techniques and methodologies are also applicable to railway systems. Modern railway systems use centralized switching stations to manage how trains are moved between tracks. This is true for both light rail (commuter and inner-city, e.g. “S-Bahns”) as well as heavy rail (freight). In many cases the switching is performed automatically, based upon predetermined schedules as well as sensor input regarding the actual position of trains on the tracks. If trains are delayed—as they often are—the switching software must perform different switching tasks. This can lead to too many enqueued, uncompleted tasks and a resulting system failure: the switching software crashes when the stack of tasks grows past its memory limit. This exact scenario has occurred at least three times in the S-Bahn rail systems in Hamburg and Berlin. The resource controller could sense this kind of overload and automatically suspend some tasks from being enqueued until the backlog was cleared.

Automobiles and smart traffic systems are another possible application of the techniques and methods described herein. A scenario envisioned for the future of automobile traffic is one in which the “driver” chooses a destination in an on-board computer, and the car drives itself to that destination. In one variation of this scenario, the cars sense their positions in traffic and maintain a minimum distance from neighboring cars (perhaps only inches) while traveling at high speeds. In order to manage the sensor input that would be needed to safely achieve this, there would need to be multiple (and possibly redundant) embedded computer systems in every car. A failure of some of the computer hardware could potentially create an overload of the kind described under the “railways” bullet; a resource controller in these systems could prevent catastrophic failure, perhaps moving the crippled automobile out of the traffic stream until it could be repaired.

Spacecraft (satellites, shuttles, stations, remotely operated vehicles) bristle with sensors that enable the craft to function correctly and to operate in dangerous environments. The sensors generate large amounts of data that can cause over-load problems which are similar to those that would be faced by the hypothetical smart traffic systems. A recent example of this is the Mars “Spirit” rover that entered a catatonic state because its on-board filesystem became full with too much data. To quote Risks Digest Volume 23, Issue 241, two problems with Spirit were “a file system that does not fail gracefully when overflowed” and “a boot sequence that requires resources that may become unavailable.” A resource controller for these kinds of spacecraft could sense the onset of this kind of resource starvation, automatically alerting the astronauts or flight engineers while simultaneously degrading resource consumption from lower-priority sensor inputs.

Yet another possible application includes flight systems. Terrestrial flight systems (both manned and unmanned) are vulnerable to many of the same kinds of overloads as spacecraft. This includes fly-by-wire commercial aircraft, as well as defense applications such as remotely operated drones and cruise missiles. In the event of sensor overload, these systems could benefit from a resource controller that sacrifices service of ancillary subsystems in favor of maintaining critical flight functions.

The examples listed are meant to be illustrative of the broad range of resource limited systems which may benefit from the techniques and methodologies described herein. However, this list is not meant to be exhaustive and other applications not mentioned are well within the scope of the claims recited herein below.

Various embodiments, applications, and technical details found in this application are based upon the James G. Garnett's PhD dissertation entitled, “Adaptive, Nonlinear, Resource-Distribution Control” from the University of Colorado, Boulder, 2004 and is hereby incorporated by reference for all purposes.

Terminology

Brief definitions of terms, abbreviations, and phrases used throughout this application are given below.

The terms “connected” or “coupled” and related terms are used in an operational sense and are not necessarily limited to a direct physical connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

Overview

According to one embodiment a controller identifies and prevents resource starvation in information systems. To function correctly, system processes require resources (such as network memory buffers) that can be exhausted when under high load conditions (such as large amounts of network traffic). If the load conditions continue long enough to completely drain the free-buffer pools in the system, these processes first starve for memory, then block, and can finally destabilize or crash the system. The methods and systems described herein seek to avoid these and other failures by distribution shaping that completely avoids undesirable states (such as that with zero free buffers). According to one embodiment, first, a distribution model of the resource usage is built based on the structure of the system. The number of states may be determined by the amount of resources, and the transition probabilities may be determined based upon the instantaneous rates of observed consumption and release. In the control stage, analytically-derived mathematical characteristics of the distribution model may be used to guide a Proportional/Integral/Derivative (PID) controller that denies some resource requests in real-time systems in a principled manner, thereby reducing the demand rate and the resulting distribution of resource states.

According to one embodiment, a controller is composed of one or more of the following components:
1. a control reference (the Quality of Service (QoS) specification);
2. a distribution model of the underlying system, such as a Markov Birth/Death Chain model of a software system;
3. a statistical filter of real-time events that calculates the model's parameters;
4. a nonlinear transform; and
5. an adaptive Proportional/Integral/Derivative (PID) feedback loop.

According to one embodiment, the QoS specification is a reference that specifies the maximum allowed probability of a given resource state. For example, the common “no free memory” state in a general-purpose computer (in which new programs fail to start and running ones slow to a crawl or crash) might be specified as a zero, meaning that it should never occur (i.e. with zero probability). The controller uses this specification by maintaining a resource's empirical probability distribution at levels equal to or below the reference. It achieves this by continuously measuring the empirical resource usage, comparing that measurement against the reference, and finally compensating to drive the former towards the latter—if necessary—by denying some requests and thereby generating recoverable faults.

In some embodiments, the QoS reference specification is completely arbitrary, and may be chosen by system administrators based upon site policies. In choosing a QoS reference, the administrator makes a tradeoff between performance and reliability: computing performance may increase as more resource requests are satisfied, but this occurs at the expense of reducing the pool of free resources and increasing the rate at which the controller may have to drop resource requests. The QoS specification will typically be designed to avoid total resource starvation regimes, and to enter so-called degenerate operating points—from which the system could quickly drop towards starvation regimes—only with very low probability. This specification represents the maximum allowable probability of entering each resource state, and control actions are taken when the empirical probability of a resource state exceeds its value.

Design constants of the controller may be determined through the use of a distribution model, such as a Markov Chain model, that captures the structure of the system, and a statistical filter that estimates parameters for it. According to one embodiment, the model is a directed graph consisting of discrete states and probabilistic transitions between them. In it, state n represents n resources in use, and a transition to state n+k with value 0<p≦1 indicates a positive probability p of k more resources being consumed. The structure of this Markov Chain—its number of states and the possible transitions between them—is a fixed function of the design of the software, whereas the probabilities associated with the transitions are a function of the demand and release rates for resources, and thus will vary according to the operating environment.

For purposes of illustration, various embodiments described herein are described in the context of so-called Birth/Death Markov Chains in which k=1, where transitions are those that only increase or decrease the state by one. This type of structure corresponds to an enormous variety of resource systems, so it is widely applicable. According to one embodiment, the number of states in the Chain is selected by determining the number of resources. From this information, the Birth/Death Markov Chain equations, and the QoS Specification, a state-transition ratio table can be generated. Using this table along with a statistical filter that generates a continuous stream of estimated transition probabilities, the controller applies compensatory control to reduce the effective demand rate. Consequently, the empirical distribution of the resource system is maintained at a level at or below the pre-defined QoS specification.

According to one embodiment, specific control actions are based upon a scaled error signal generated from the difference between the empirical distribution and the QoS specification. The scaling may be a nonlinear function, tailored to each system, and designed to capture the fact that some state transitions are more destabilizing than others. As resources drain, for example, the software system performance may slowly degrade, but then drop off suddenly when some critical low watermark is passed—such as when an Internet packet router receives more traffic than it can process. In this case, the latency through the router may increase slowly as the processor tries to keep up, and then may suddenly become infinite when the internal packet buffer pool is emptied.

In yet other embodiments, methodologies discussed in more detail below are designed to overcome quasi-stability and encourage rapid mixing. Since the quasi-stable effect is probabilistic it may or may not occur in the course of a chain's convergence to stationarity. In various of these embodiments a nonlinear transform is used to “nudge” the chain into convergence. One possibility is to use probabilistically scale the error signal possibly preventing integrator windup, quasi-static convergence effect, and other undesirable effects.

However, various methods and techniques described herein seek to handle such sudden changes by exaggerating the error signal for dangerous transitions. One way of exaggerating is to scale the error signal. The scaled error signal may then be used by the controller as the measure of the degree of compensatory control that should be applied, resulting in a faster control response in critical operating regions.

In other embodiments, a nonlinear transform may be used to temporarily allow the model to make difficult state transition without causing the Integral state of the controller to produce a large error. A small and rare enough nudge may improve the mixing rates while not affecting the stationary probability to which the chain converges. In many of these embodiments different transforms may be used. For example, one option is to probabilistically scale the error signal in the controller when the relative pointwise distance value is close to 1.00.

According to one embodiment, the drop probability is computed from the scaled errors in order to attain the desired reference using Proportional, Integral, Derivative (PID) control, a traditional control theory method. The input to this type of feedback loop is the scaled error, and the output is a linear combination of the error (its magnitude), the integral of it (the amount by which the magnitude has differed from the control goal over time), and its derivative (how rapidly its magnitude is changing).

Each component of the feedback loop possesses a tunable gain constant, and thus any combination of P, I or D components may be used for a specific software system or set of operating conditions. A strictly P-type feedback loop, for example, with the gains for the Integral and Derivative stages set to zero, would deny requests for resources with a probability in strict proportion to the size of the error (that is, to the difference between the QoS reference and the predicted probability from the Markov Chain model). The relative influences of the P, I and D components are governed by gain constant values for each. P, I and D may be chosen according to well-established heuristic methods. These constants are not completely fixed, however, as the technique of gain scheduling may be used to change the constants in the event of altered system operating conditions.

According to one embodiment, the table of gain constants is calculated such that the controller reacts appropriately to the operating environment. For example, is may be satisfactory to employ a simple P-type feedback loop when resources are plentiful and demand upon them low, for instance, but an increasingly more powerful Integral and Derivative control might be introduced in order to increase the overall response speed at the expense of controller stability if demand rates increase. Such a controller is therefore adaptive and can prevent system failures in situations where static control strategies would not.

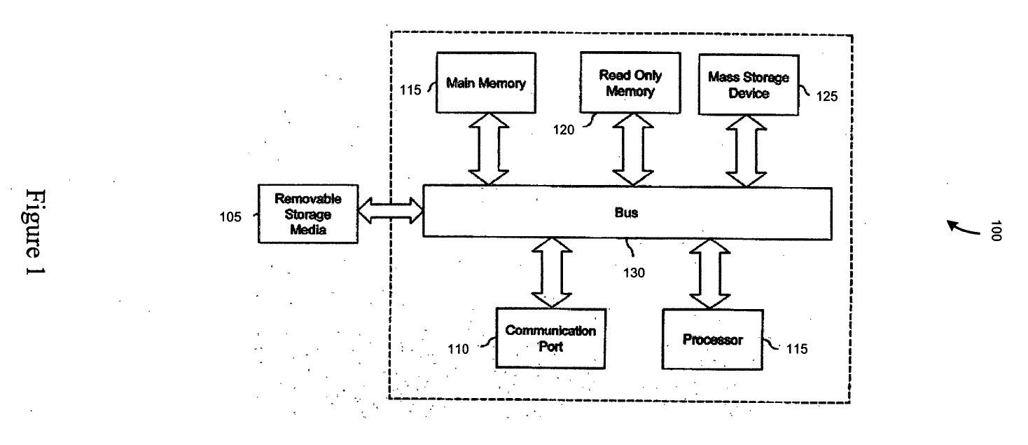

Embodiments of the present invention include various steps, which will be described in more detail below. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 1 is an example of a computer system 100 with which embodiments of the present invention may be utilized. According to the present example, the computer system includes at least one processor 105, at least one communication port 110, a main memory 115, a read only memory 120, a mass storage 125, a bus 130, and a removable storage media 140.

Processor(s) 105 can be an Intel® Itanium® or Itanium 2® processor(s) or AMD® Opteron® or Athlon MP® processor(s). Communication port(s) 110 can be any of an RS-232 port for use with a modem based dialup connection, a 10/100 Ethernet port, or a Gigabit port using copper or fiber. Communication port(s) 110 may be chosen depending on a network such a Local Area Network (LAN), Wide Area Network (WAN), or any network to which the computer system 100 connects.

Main memory 115 can be Random Access Memory (RAM), or any other dynamic storage device(s) commonly known in the art. Read only memory 120 can be any static storage device(s) such as Programmable Read Only Memory (PROM) chips for storing static information such as instructions for processor 105.

Mass storage 125 can be used to store information and instructions. For example, hard disks such as the Adaptec® family of SCSI drives, an optical disc, an array of disks such as RAID, such as the Adaptec family of RAID drives, or any other mass storage devices may be used.

Bus 130 communicatively couples processor(s) 105 with the other memory, storage and communication blocks. Bus 130 can be a PCI/PCI-X or SCSI based system bus depending on the storage devices used.

Removable storage media 140 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

The components described above are meant to exemplify the types of possibilities. In no way should the aforementioned examples limit the scope of the invention, as they are only exemplary embodiments.

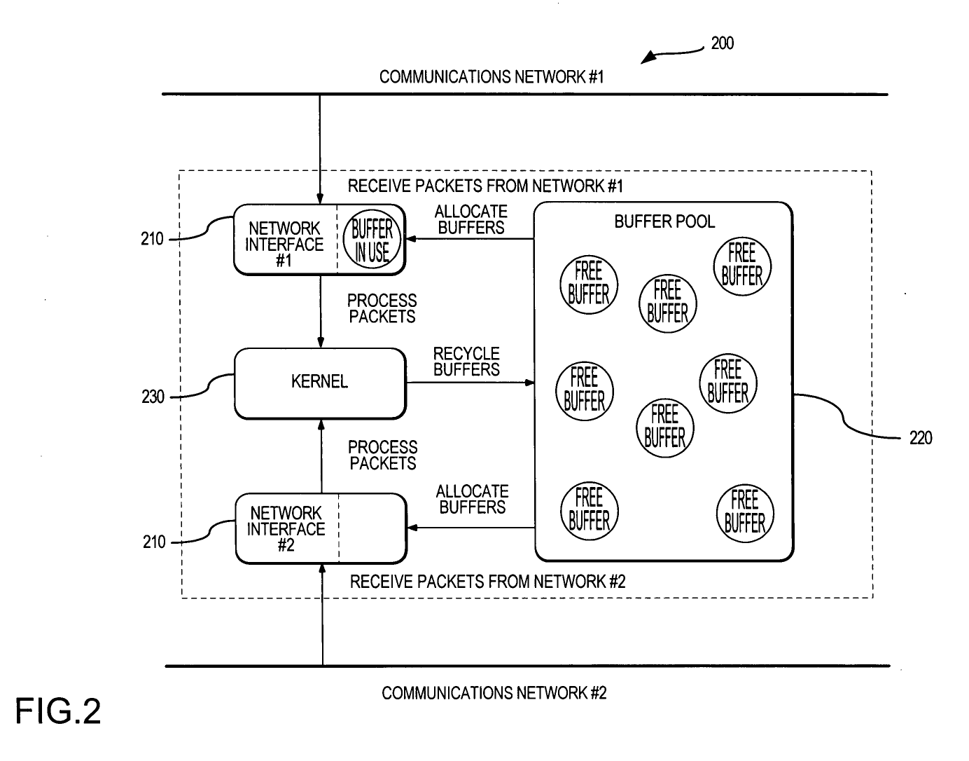

Various details and reasoning behind the modeling, scaling, filtering, and compensation stages of an exemplary controller are illustrated in the following sections using a simplified network communications model, as shown in FIG. 2. This example consists of two independent communications networks and a computing system with connections to both. Internal to the system of FIG. 2 are:
the devices that receive packetized data, the network interfaces 210;
a common pool of N memory buffers 220 that are used to store the data contained in incoming packets, where N is the total number of such buffers; and
a kernel unit 230 that processes the data buffers and then recycles them back to the shared pool.

Although actual network systems are much more complex than this example, for sake of brevity, the simplified network communications model is used herein without loss of generality. Those of ordinary skill in the art are capable of understanding how every stage of the derivation and application in the following paragraphs scales easily to more complex systems.

The communication system 200 in FIG. 2 is susceptible to failure when the buffer pool 220 is completely emptied, a situation that would occur if packets arrived on the network interfaces faster than buffers could be recycled by the kernel. In particular, it is possible for excessive traffic on one interface to drain the pool, thereby precluding any packet reception on the other—even though there may be little traffic on that interface. Embodiments of the controller described herein can prevent such “Denial of Service” situations from affecting the system by ensuring that free network buffers exist, which allows network communications to proceed on the unattacked interfaces, and averts system crashes due to buffer pool drainage.

In the following sections an exemplary stochastic model, a Markov Chain model, of the system is derived, and then statistical filters are used to estimate the state transition rates of the model. Discussion then turns to possible reference distributions for the system, and how nonlinear scaling can be used to achieve better performance than linear control systems. Finally, a simple PID controller is described that can prevent a Denial of Service attack. These exemplary embodiments described below for the stochastic model, the statistical filters, the error pre-conditioning, and the controller are meant to be illustrative rather than limiting. As such, those with ordinary skill in the art will be able to apply variations and other methods that are well known.

Control Reference

According to one embodiment, the control reference is a specification that defines the maximum desirable probability with which the system may enter a given state, and the engineer using the methods and techniques described herein may design this reference such that the system avoids failure points and the degenerate states that lead directly to them.

In the example illustrated in FIG. 2, the most relevant failure point is when no free buffers are in the shared buffer pool 220. One step away from this is the degenerate regime, where only one buffer remains in the free pool. In that situation it is possible to enter failure when even one packet arrives on the network interfaces. The normal practice in actual network systems, which have analogous failure modes, is simply to provide far more buffers than would be needed in ordinary operating conditions, which is not only a waste of resources but also ultimately does not solve the problem since extraordinary conditions will drain the buffer pool anyway.

According to one embodiment, an engineer may choose the QoS reference such that the system enters a failure state with zero probability, implying that the controller must deny all buffer requests when the shared pool is empty. However, rather than simply accepting all requests until n−1 buffers are in use—which is the normal response of current resource management systems-according to one embodiment, performance is instead degraded gracefully as the pool drains, sacrificing individual subsystem performance for overall system reliability. Driven by this rationale, the engineer may choose a QoS specification that allows the system to approach and enter degenerate states with a positive, monotonically decreasing probability. The alternative tactic-grant every request until nothing is left in the pool, and then deny each successive one-uses no knowledge about the system to degrade access to resources in a controlled fashion, and so failure (when it comes, as it inevitably will) is sudden, unexpected, and often catastrophic.

Depending on the QoS reference, the controlled system can perform in any one of the spectrum of choices from slow to rapid service degradation; hence the QoS reference is the way for the engineer to specify how the resource system should perform as it approaches starvation.

When designing the QoS specification, the engineer may choose between control and performance: a highly-controlled system with large QoS reference probabilities results in large numbers of dropped resource requests and a resulting lower rate of serviced requests. The two possibilities for the scaling curve for a system with 256 buffers (and hence 257 states) illustrate that the quadratic choice produces a lower performance hit than the linear alternative since its reference probability is higher (meaning the controller may need to drop fewer requests), at the expense of a more rapid drop in performance as the system approaches the failure state (since the slope of the quadratic reference is steeper than that of the linear version near state zero). An important property of the reference is that it is not a full function of the state. In this example, there are 257 states in the actual system, but only 246 through 256 are specified in the reference. According to one embodiment, unspecified states are don't-cares: the feedback loop will not apply control, and the system enjoys the potential for its highest performance. Conversely, specified states may be entered no more often than the reference dictates, so the controller degrades performance in order to meet the specification. In general, the more states for which a control reference is defined, the more resource requests will be lost. Thus, over-specifying the reference when such a specification is unnecessary, e.g. when no buffers are in use (state 0 in the example of FIG. 2), is discouraged.

Exemplary Model

According to the present example, the next step in implementing the controller is to model the resource limited system, e.g. a communication system, by a stochastic process. One embodiment uses a Markov Chain to provide a way to derive the predicted resource distribution. If the predicted distribution can be made to be equal to the QoS specification, then the controller will produce correct behavior.

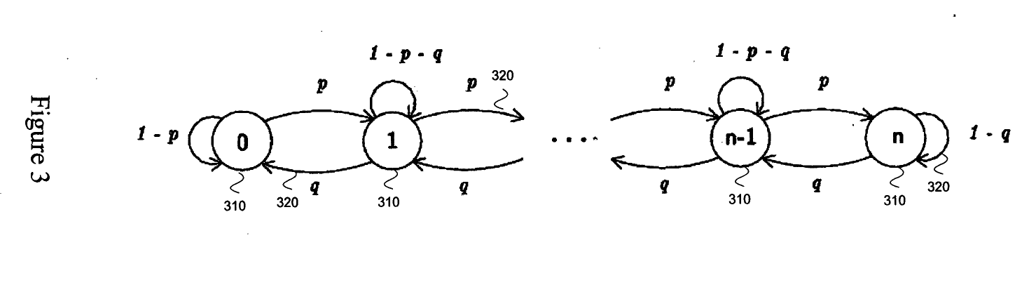

A Markov Chain is a mathematical abstraction of a stochastic process, such as the ebb and flow of buffers in the shared pool, that may be visualized by graphs like the one in FIG. 3, with one vertex 310 for each state and directed edges 320 for possible state transitions. The states represent the specific, discrete values that may be assumed by the process, while the edges are annotated with the probability of the associated state transition. In the present example, the state represents the number of free buffers in the shared pool at a given time. The model's structure is thus influenced by both the configuration of the system and the rates of packet arrivals and buffer recycles: the number of states is one more than the number of buffers (to include state zero), and the transition probabilities are functions of the rates of packet arrivals and buffer recycles by the kernel.

For purposes of illustration, the structure of the model is simplified by various simplifying assumptions made herein about the system: (1) that no more than one packet arrives at any time; (2) that the kernel recycles at most one buffer at a time; and (3) that buffer allocations and recycles do not occur simultaneously. If i buffers are in use (state i), then at any instant the system can remain in state i, or else transition into state i+1 (if a packet arrives), or to state i−1 (if the kernel recycles a buffer). Assuming that it is not in the terminal states, n or 0, respectively. The probability that it will make a transition is a function of the rate of packet arrivals and the speed with which the kernel processes packets. These assumptions guarantee that buffer allocations and recycles occur sequentially and in unit increments, and therefore that the Birth/Death Chain model will be applicable. An enormous variety of resource systems manage buffer pools in exactly this fashion, making this a powerful model. The graph of FIG. 3 captures these ideas and serves as an example model for various embodiments described herein.

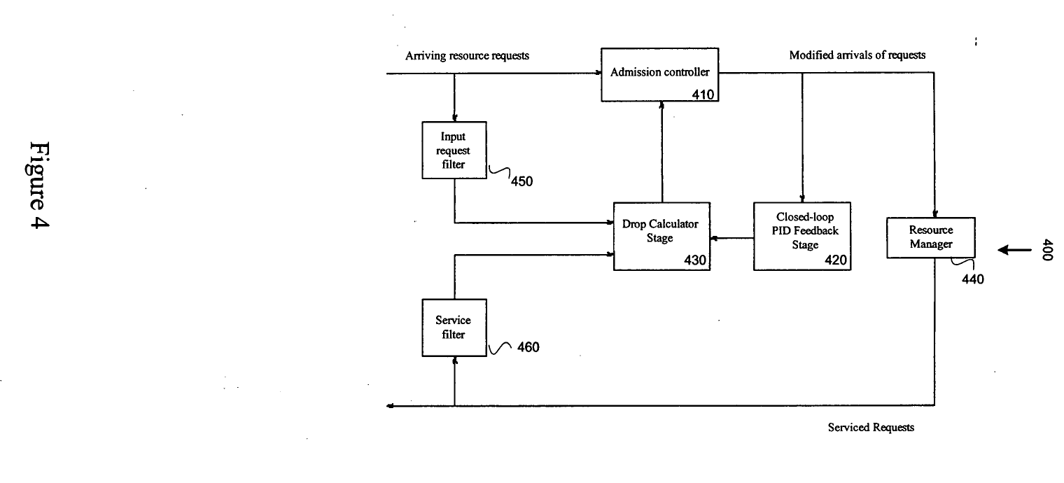

Using this Markov Chain, an analytical expression for the predicted distribution of system resource usage can now be derived. The Birth/Death Markov Chain model is well-known in the literature, and its trend based on p and q (the packet arrival and buffer recycle probabilities, respectively) is given by the expressions:

$$\begin{matrix}{π}_{0} = {( {\sum }_{i = 0}^{n} \frac{{p}^{i}}{{q}^{i}} )}^{- 1} & ( 1 ) \\ {π}_{i} = \frac{{p}^{i}}{{q}^{i}} {π}_{0} 0 < i \leq n & ( 2 )\end{matrix}$$

where πᵢ; represents the probability that the model is in state i and n denotes the maximum state. The set {π₀, π₁ . . . , πₙ} is called the stationary distribution of this Markov Chain. Given a fixed pair of transition probabilities p and q, the stationary distribution is also fixed, and takes three distinct forms when p<q, p=q, and p>q, as shown in FIG. 4. This figure shows the stationary state-probability distribution of a 257-state Birth/Death Markov Chain, which would be applicable to the communications system example if it possessed 256 memory buffers. The probability mass accumulates in lower-numbered or higher-numbered states when p<q or p>q, respectively, and is equally distributed when p=q. Informally, this provides exactly what is desired: the probability of having free buffers is high when the rate of kernel buffer recycles (q) is higher than the rate of packet arrivals (p), stable and unchanging when the two rates are equal, and low otherwise.

Since the control method shapes the distribution by dropping resource requests (i.e., lowering p), the relationship between the transition probabilities and the stationary distribution is determined. If the probability, denoted by Pᵢⱼ, of the chain making the transition into state j when it is in state i, then for the Birth/Death Markov

Chain the relationship is:
πᵢPᵢⱼ=πⱼPⱼᵢ (3)

This is known as the time reversibility equation in the theory of Markov Chains, and illustrates that the stationary probability of any state is fixed with respect to that of its neighbors. Moreover, from Equation (3), it can be inferred that the ratio of the transition probabilities is more important than their absolute values. The equation can be rewritten as πᵢ₊₁=rᵢπᵢ to illustrate this more clearly. Since various embodiments described herein are described with reference to Birth/Death chains—in which the state changes by at most one—this equation refers to πᵢ₊₁ and πᵢ instead of the more general πᵢ and πⱼ. Herein, the constant rᵢ is referred to as the transition ratio between states i+1 and i. By manipulating the transition ratio, the stationary probability of any state relative to those of its neighbor states can be changed. Equation (3) establishes the connection between the transition ratio and the stationary distribution; there is also a relationship between the transition ratio and the transition probabilities given by:
pᵢ=rᵢqᵢ₊₁ (4)
where pᵢ is the probability of transitioning from state i to state i+1 in a Markov Birth/Death Markov Chain and qᵢ₊₁, is the probability of making the reverse transition, then pᵢ=rᵢqᵢ₊1. Hence the transition ratio is a constant that relates the stationary probabilities of the Chain to its transition probabilities:

$$\begin{matrix}{r}_{i} = \frac{{π}_{i + 1}}{{π}_{i}} \\ = \frac{{p}_{i}}{{q}_{i + 1}}\end{matrix} \qquad ( 6 )$$

As previously described, in various embodiments the state distribution is controlled. FIG. 4 illustrates a high level block diagram of the system setup 400 according to one embodiment. The embodiment illustrated contains admission controller 410, feedback stage 420, drop calculator stage 430, resource manager 440, input filter 450, and service filter 460.

The admission controller 410 determines if an arriving resource request should be admitted or denied access to the resource system. In order to make this determination the closed-loop feedback stage 420 compares the current state distribution with the desired distribution. In one embodiment, the feedback stage 420 may be a nonlinear PID controller described in more detail below. The resulting signal along with the estimate of the unmodified input request probability, the output of the input request filter 450 in the embodiment illustrated, and service probability, as estimated by the service filter 460 in the embodiment illustrated, are utilized by the drop calculator 430 to estimate the desired drop probability which will steer the empirically measured distribution of modified resource request toward the desired distribution.

The behavior of the model and closed loop system depends critically on the edge transition rates p and q, so these values are adjusted to reflect the actual target systems. According to one embodiment, this may be accomplished by using a statistical filter, 450 and 460, to estimate those parameters, as illustrated in the next section.

Filtering

To estimate edge-transition probabilities for the Markov Chain model from the raw data of the exemplary target system (arriving packets and buffers being recycled back to the free pool), a statistical filter is used to remove the noise that is inherent in any experimental system. For example, network traffic is bursty, so long periods of quiescence may be followed by large numbers of packet arrivals; a simple average of the number of packet arrivals over some time period could give the misleading impression that packets were arriving at a consistent, low rate. The goal of the statistical filter is to answer the following question: given the pattern of packet arrivals (buffer allocations) over the previous time periods, how many arrivals (allocations) will occur in the next time period?

A reasonable answer would be provided by a weighted, moving average filter of some kind, such as an exponentially-weighted, moving average filter. This is different from a simple moving average, which gives historical data the same importance as more-recent data. For example, if Aₜ represents the number of buffer allocations in the current 10 millisecond interval and Aₜ₋₁ is the number of allocations in the previous 10 millisecond interval, then the simple moving average (SMA) at time interval t (the current plus previous 40 milliseconds of time) is given by:

$${SMA}_{t} = \frac{{A}_{t} + {A}_{t - 1} + {A}_{t - 2} + {A}_{t - 3} + {A}_{t - 4}}{50}$$

This value represents the average number of allocations per millisecond over the last 50 milliseconds, but it assumes that this value is meaningful—which will only be so if the arrival rate is unchanging and steady (in the probabilistic sense, such as in a Poisson process). If the rate is changing slowly over time, then Aₜ is more meaningful in terms of calculating the true current allocation rate than Aₜ₋₄. By exponentially weighting previous measurements, the exponentially-weighted moving average can be created by:
EWMAₜ=EWMAₜ₋₁+α(Aₜ−EWMAₜ₋₁)
where EWMAₜ; is the exponentially-weighted moving average with weight γ(0<γ<1) over time interval t. Here γ is the “smoothing” or “weighting” percentage, and represents the amount by which the influence of previous values of Aₜ is reduced. If γ=0.2, then the effect that Aₜ has upon the EWMA is degraded by 20% at each successive iteration; after five future iterations, Aₜ has essentially no influence on the moving average. Both of these moving averages are essentially simple, linear filters. More complex filtering mechanisms, such as Kalman or Particle filters (which need only information about the distribution of errors around the arrival rate, rather than the distribution of arrivals themselves) can add more degrees of sophistication—including nonlinearity—in order to tailor the parameter estimation for any application.

Once the allocation and recycle counts have been determined via some type of filter that the engineer chooses, the control system may use them to calculate the edge-transition probabilities. Assuming that the transition probabilities are not state dependent (which is a valid assumption), then a simple counting argument can be used. If the filtered buffer-allocation count is a and the filtered recycle count is b, then the edge transition probabilities for states 1 through N−1 are given by:

$$\begin{matrix}p = \frac{a}{a + b} & ( 7 ) \\ q = \frac{b}{a + b} & ( 8 )\end{matrix}$$

since each state has a total exit count of a+b. Using these equations in combination with Equation (6), the controller calculates a drop probability that it uses to decide when to drop requests. Dropping requests results in a change of shape in the empirical distribution of resources, and this difference in mass between the empirical distribution and the QoS specification is then scaled and used by the controller as the feedback input to exactly match the specification.

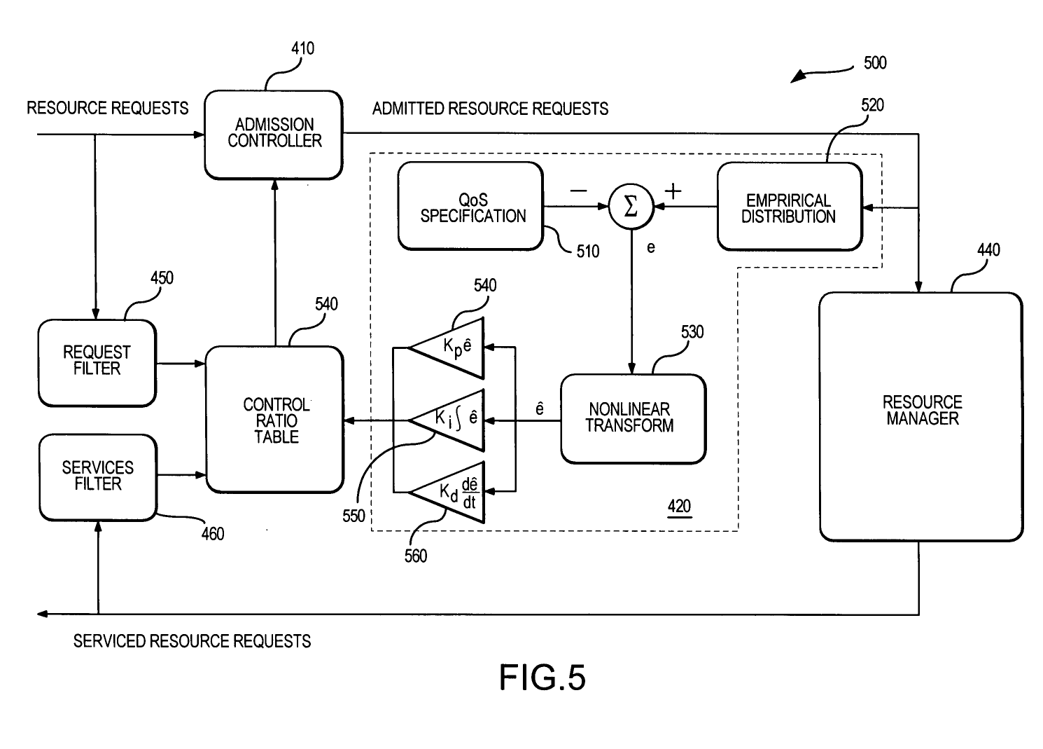

FIG. 5 illustrates an intermediate level block diagram description of the system 500 according to one embodiment. The admission controller 410, resource manager 440, request filter 450, and service filter 460 are the same as in FIG. 4. However, the closed loop feedback stage 420 and drop stage calculator 430 have been expanded to show more details according to one embodiment. In this exemplary diagram, a specified QoS 510 is provided and compared with the measured empirical distribution 520 of admitted requests. The difference between these two measurements is then fed into a preconditioning nonlinear transform 530 to produce a modified or scaled error signal. The error scaling is discuss in more detail below.

In the embodiment depicted, a Proportional 540, Integral 550, and Derivative 560 controller is shown. However, the controller need not be limited to this structure. In any event, the output of the control signal, in the case the sum of the output of the Proportional 540, Integral 550, and Derivative 560 is used to index into a control ratio table 540 to estimate the desired drop probability to be used by the admission controller 410.

QoS Specification

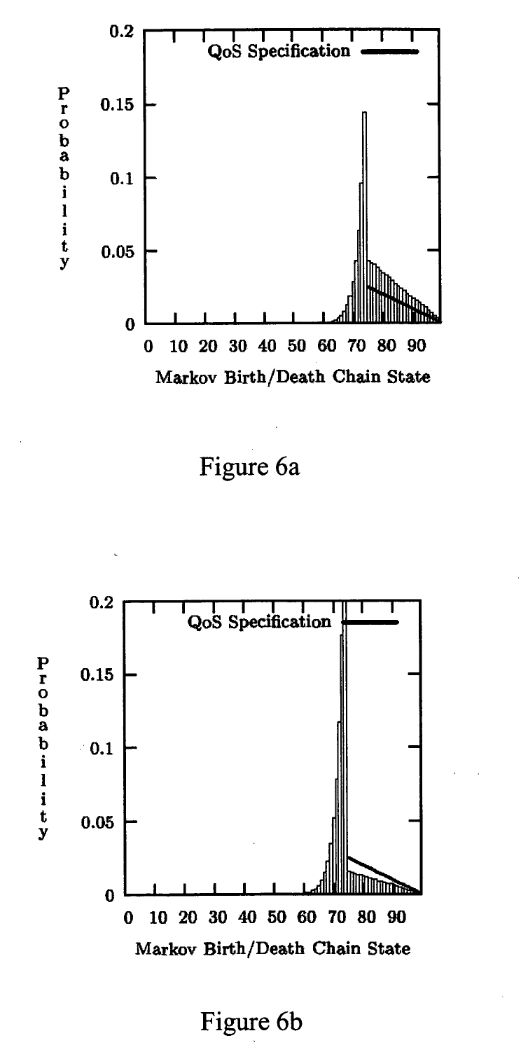

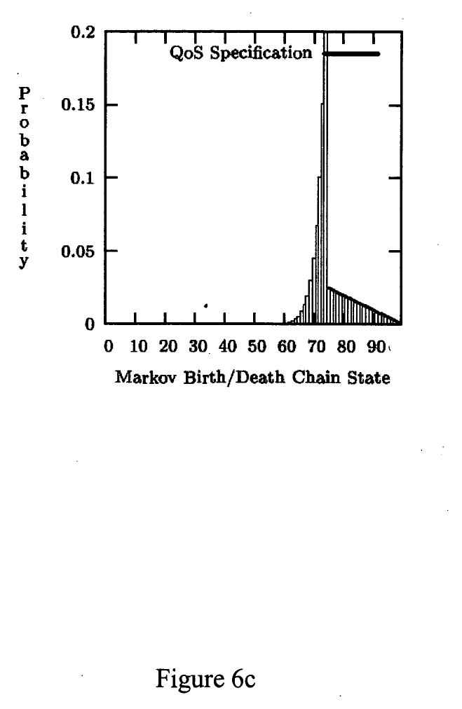

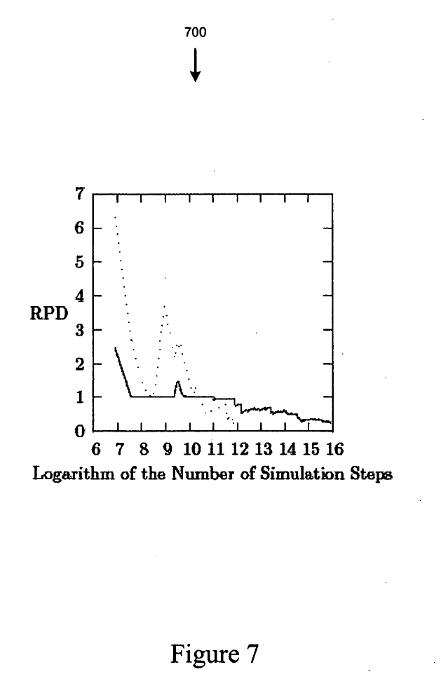

FIGS. 6a-6c depict possible distributions in relation to a specified QoS control specification in accordance with one embodiment of the present invention. FIG. 7a is an illustration of the state distribution 610 and a linear QoS specification 620 when the transition ratio matrix is appropriately set. FIGS. 6b and 6c illustrate a linear QoS specification 620 and a probability distribution 630, 640 when the transition ratio matrix is set too low and too high, respectively. As a result, the accumulation of too much or too little probability mass in the QoS-constrained states will occur. According to some embodiments, the vector difference between the QoS specification 620 and the stationary distribution 610, 630, or 640 may be used with feedback control to determine the correct value of the transition ratio matrix in order to obtain the appropriate accumulation of probability mass under the QoS specification 620.

Error Scaling

According to one embodiment, nonlinear scaling 530 is used to adjust for the fundamental linearity of a PID feedback loop. Consequently, as described above, higher system performance can be achieved by applying heavier control in failure and degenerate states and lighter control in acceptable operating regimes. According to one embodiment, the controller uses three pieces of information:
the instantaneous state (measured);
the empirical stationary distribution 520 of the system (measured and accrued), given the current operating conditions; and
the QoS control reference 510 (specified), S, which represents the desired stationary distribution.

The disparity between the control reference and the empirical distribution is called the error; formally, the error (e) is the distance between the empirical distribution and the control reference:

$$e = {\sum }_{i ∈ S} ( E ( i ) - {s}_{i} ) \qquad ( 9 )$$

for any state (i) that is defined in the control reference, having empirical stationary probability E(i) and a reference value of sᵢ. The error represents the total difference in probability mass between the control reference and the measured behavior of the system; its value ranges between—1.00 and 1.00.

However, not all errors are equal. A small error may be nothing more than a slight over or underestimate of the transition probabilities in the filters, but a large error would indicate a significant change in operating conditions, such as a suddenly increased demand for resources. Larger errors, thus, mean that the system is further out of its control specification, so the importance of a given error is state-dependent: if resources are exhausted in state i, then the arrival of one more request may cause system failure, which would not be the case in state i—10. This idea is formalized to some degree in the QoS control reference specification, but that specification quantifies only what must happen, not how it might be achieved. It should be clear, therefore, that the controller may be configured to take more drastic control actions in degenerate states than in others.

In the current communications system example, the controller might only need to prevent up to i allocations from occurring in any state i when i>1, but if i=1 it must stop all allocations—i.e. refuse all requests (which is effectively what happens when the system fails). Linear controllers cannot provide nonlinear responses: if a small error generates a small compensation response, it does so regardless of the state. Consequently, a better approach is to respond in a state-dependent, nonlinear manner so that small errors in states close to failure are corrected much more quickly than those that are not. In order to achieve this, embodiments of the present invention scale the error using a nonlinear scaling function.

The scaling function 530 can depend on a variety of factors, including the controller's response speed, but in general is designed to amplify the error in degenerate states and to create an infinite error in failure states. A reasonable scaling function for the present example might be:

$${f}_{i} = \frac{1}{i} + 1 \qquad ( 10 )$$

which makes the scaled error:

$${e}_{i} = ( \frac{1}{i} + 1 ) ( {π}_{i} - {}_{}^{′}{s}{}_{i}^{} ) \qquad ( 11 )$$

This makes the scaled error infinite in the failure states, greatly exaggerates it in the degenerate states, but does not add a significant amplification in other states. The result of using this modified error signal in the feedback loop will be higher overall system performance, since amplification (and therefore increased control response) will occur only in operating states where it is necessary.

In some situations the Markov Birth/Death Chains appear to mix rapidly. Under certain circumstances, however, the mixing rate may slow due to an effect called quasi-stability. A quasi-stable Chain is one that converges rapidly to an intermediate, non-stationary distribution, and then only slowly evolves towards its true stationary limit. Although these Chains still mix rapidly in the sense that although the average number of steps required to converge is asymptotically linear, they will do so at a slower rate. This quasi-stable effect is probabilistic and hence non-deterministic: it may or may not occur in the course of a Chain's convergence to stationarity. Because quasi-stability can slow mixing by several orders of magnitude (as will be demonstrated in this section), thereby significantly degrading the performance of controllers.

Some embodiments are designed to reduce the occurrence of quasi-stable events. Quasi-stability can be identified through a convergence plot, such as FIG. 7. Two convergence traces are shown. The figure plots the number of simulation steps versus relative pointwise distance for the two simulations. The simulations were identical, in the sense that the same Chain, transition probabilities, and QoS specification were used for both simulations; the only difference was the random seed used to start the simulation. (The random seed determined the exact sequence of upward and downward state transitions, but not their overall distributions.) The dotted trace shows a quickly-converging simulation run that rapidly achieves an rpd of 0.25. The solid-line trace is a simulation run that became quasi-stable, displaying the characteristic of quasi-stability: a plateau at an rpd of 1.00. The cause of this the Chain state failing to transition into one or more states in the QoS specification region. To understand why the value of 1.00 is special, recall that the rpd is calculated as the difference between the empirical probability mass in the QoS-specified states and the QoS specification, normalized by the sum of the mass in that specification:

$$∈ = {max}_{i} \frac{\vert {E}_{i}^{Δ t} - Q ( i ) \vert}{Q ( i )}$$

If the Chain state does not transition into one or more QoS-specified states, then the empirical mass (Eᵢ^{Δt}) will be zero, and hence E will equal 1.00.

The source of quasi-stability is a phenomenon related to the law of large numbers. This law states, informally, that a sample distribution of a random variable will approach the variable's true distribution as the sample size grows. Consider the case of flipping a fair coin. The ratio of heads to tails in an infinite number of flips is 1.00, a fact that will be reflected in the distribution of heads and tails of large samples. However, small series of coin flips can exhibit short-term deviations from the underlying distribution without affecting the long-term limit of that distribution. A set of ten flips in which all ten are heads is just as probable, for example, as a set of flips in which five are heads and five are tails.

It is this small-scale dynamical structure that leads to quasi-stability: sometimes a Markov Chain may not transition into a given state over an extended period of time, even though that transition may possess a relatively large probability. However, just as in the coin-flips example, an infinite number of Chain steps will result in convergence to the stationary limit, regardless of whatever temporary variations may occur. These temporary variations, which are what I call quasi-stability, can degrade the performance of a distribution controller by forcing it to use a long Ai time constant when computing the empirical distribution. FIG. 7 clearly shows that quasi-stability can have a significant and deleterious effect upon mixing rate in the short term. In that figure, the quasi-stable Chain required four orders of magnitude more steps to converge. Hence an important control goal is to identify a mechanism by which quasi-stability can be avoided and the mixing rate improved.

In one embodiment a nonzero integral gain constant, Ki, may be used. The purpose of Integral stages, in general, is to compensate for steady-state errors, and since a Chain that is stuck in a quasi-stable regime will exhibit a large controller error over an extended period of time, incorporating such a stage would appear to be an obvious solution. This may have some serious drawbacks in some instances. An integral stage increases the order of the controller which could lead to instability, as is well know to those skilled in the art. This added control stage might also have associated computational overhead. One significant problem, however, is that Integral stages are intended to compensate for the inherent steady-state error that results from using finite proportional gains, and not to correct for non-deterministic effects. When used improperly, an Integral control stage may induce effects such as integrator windup and saturate the control system. Integrator windup results when the controller reaches its actuator limits without achieving zero error between the control reference and the plant output. When this happens, the feedback is essentially broken and the controller runs as an open loop. If integrating action is used in the controller, it will continue to integrate and the integral term will become very large or “wind up;” only very large negative errors will allow the control system to recover, resulting in long term instability. In some instances a quasi-stable plant could lead to a saturation of R_{β-1}, which would allow too much probability mass to accumulate in the QoS-specified region.

One possible alternative is to use a nonlinear transform to “nudge” the Chain into convergence. The idea is to temporarily increase the conductance between state β−1 and state β, allowing the Chain to make this difficult state transition without causing the Integral stage to produce a large error. A small (and rare) enough nudge will not affect the stationary probability to which the Chain converges, but it can drastically improve mixing rates.

Many different kinds of transforms can be useful for this. One alternative is to probabilistically scale the error signal in the controller such that it is temporarily amplified if the Chain is in state β−1 and the rpd value is close to 1.00. This would have the effect of increasing the probability that the Chain will transition into the QoS-specified subset.

Control

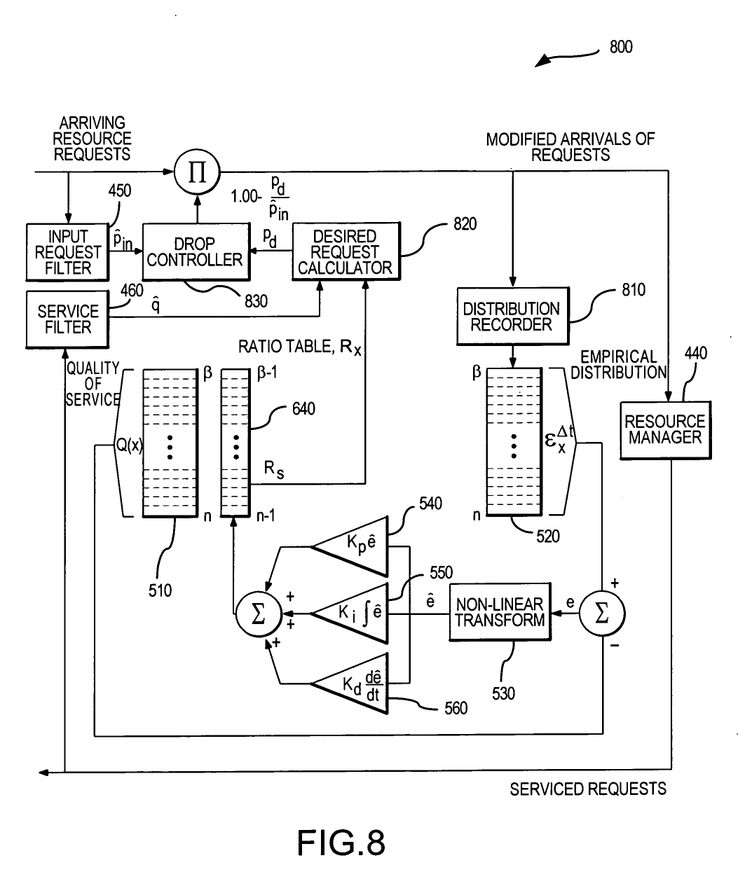

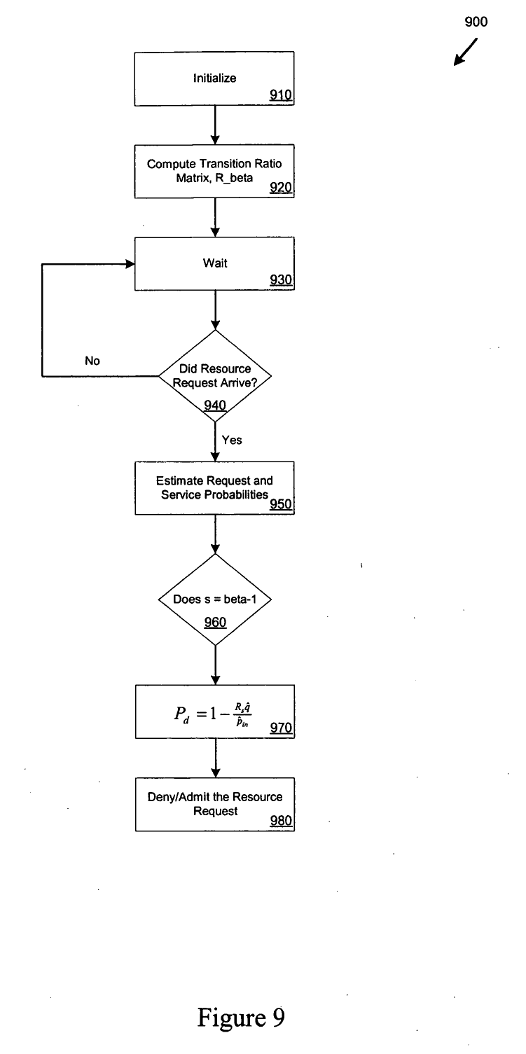

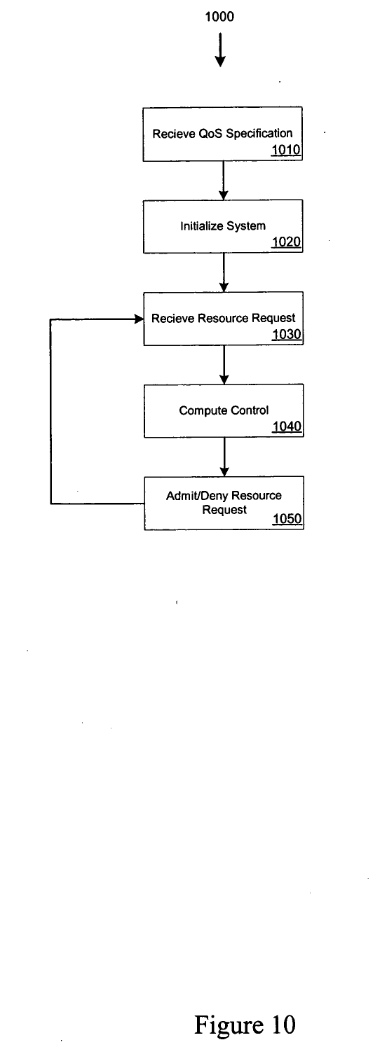

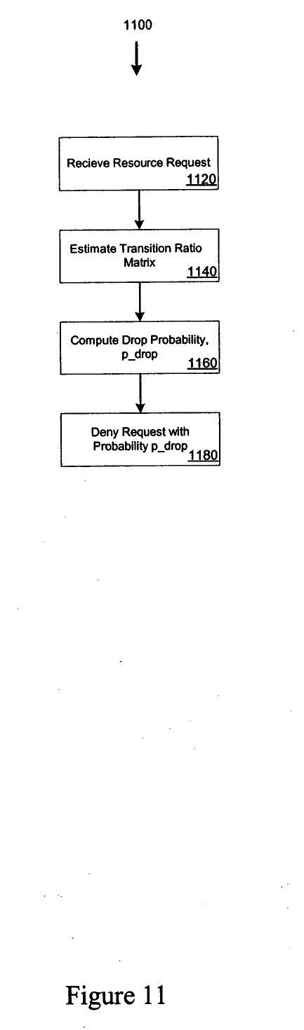

The final component of the method is the controller that modifies the rate of resource requests in order to ensure that the empirical distribution of resource states does not exceed the QoS specification. FIG. 8 represents a detailed block diagram of the system 800 according to one embodiment. According to the embodiment depicted in FIG. 8, the controller consists of a two-tiered system comprised of an open-loop stage and a closed-loop feedback stage. The closed-loop feedback stage is represented in FIG. 8 as a Proportional/Integral/Derivative blocks 640, 650, and 660. This is just one example of a closed-loop feedback stage. Other examples include, but are not limited to a Proportional (P) controller, a Proportional/Integral (PI), a Proportional/Derivative (PD) controller, and the like. The PI-only configuration is very common; the Derivative section is not always needed in every application. Other controller structures and techniques are well known to those skilled in the art and may be used in place of, or in conjunction with controllers that fall within the PID family as just discussed. According to other embodiments, lead-lag controllers, nonlinear controllers, and the like are examples of other possible control structures.

The open-loop portion of the embodiment depicted in FIG. 8 calculates the drop probabilities to decide if a resource request should be dropped. It does this using the estimated arrival rate of resource requests and a transition ratio table 640. In one embodiment, the transition ratio table 640 is computed at system startup from the QoS specification, by the control software. The closed-loop stage corrects errors between the specification and the empirical distribution.

An exemplary method to calculate the transition ratio table for the open-loop controller, algorithm that implements the open-loop controller, and two-tier architecture will now be described with reference to the network communications example.

First, the parameters of the example, some of which have been described above, are defined. Assume a 10-state Birth/Death Markov Chain, with states numbered from 0 to 9, that models the network system (hence there are nine buffers in it). The stationary distribution of the Chain, \vec{π}, is a 10-element vector in which πᵢε\vec{π} represents the long-term probability of the Chain being in state i, as described above. The control reference, \vec{S}, is a 10-element vector in which element sᵢε\vec{S} represents the maximum desired probability that the controlled Chain be in state i. Without loss of generality, it is assumed that there exists a single state βε\vec{S} for which ∀i≧β, sᵢ>0.00 and ∀i<β,sᵢ=u where u indicates that the element is undefined. For reasons that will become apparent, state β is called the bottleneck state. The constrained probability mass, π_{c}, is the sum of the elements of \vec{S}, i.e. π_{c}=Σᵢⁿ⁺¹sᵢ; where π_{c}<1.00. The free probability mass, π_{f}, is 1.00−π_{c}. For the purposes of calculating the free and constrained masses, undefined elements in \vec{S} are assumed to be equal to zero.

Given this, the control method is now outlined. Recall, from Equation (6) that in a Markov Birth/Death Chain, the stationary probability of any state is related to its predecessor state by the fixed transition ratio, r:

$$\begin{matrix}{r}_{i} = \frac{p}{q} \\ = \frac{{π}_{i + 1}}{{π}_{i}}\end{matrix}$$

For example, if π₄=0.03 and r₄−2.0, then π₅=0.06. The value r₄=2.0 means that that demands for buffers are occurring with twice the probability than buffers are being recycled back to the system. Hence if r doubles, then the relative stationary probabilities double as well. According to one embodiment, the control system modifies pᵢ (the probability of admitting a resource request) and thereby changes r, in a manner such that the stationary distribution is equal to the QoS specification, i.e.:

$$\begin{matrix}{r}_{i} = \frac{{π}_{i + 1}}{{π}_{i}} \\ = \frac{{s}_{i + 1}}{{s}_{i}}\end{matrix}$$

While q could also be changed (slowing down buffer recycles), this would actually decrease the performance of the buffer management system. The method, according to one embodiment of the present invention, consists, therefore, of three basic steps:
1. Selecting the QoS specification (done once by the system administrator)
2. Calculating the transition ratios from the QoS specification (done once by the control software)
3. Reducing the arrival probability, p, as needed to maintain the transition ratios (done on a continuous basis by the control software).

The first two steps are the initialization steps, and the third is the control step. This control step consists of an open-loop stage that calculates how much to reduce the arrival probability, and a closed-loop stage that corrects errors in the open-loop controller.

According to one embodiment, the Open-loop Control Algorithm is used to implement the open-loop stage of the control step, in which buffer requests are dropped. This algorithm may be implemented as part of the control software, and it consists of four steps:
1. Calculating the current estimated request and service probabilities from the statistical filter, \hat{p}ᵢₙ and \hat{q}, respectively.
2. Calculating the desired request probability, pᵢ, for the current state i using the transition ratio table and the estimated service probability: p_{d}=1.00/(r(i)×\hat{q}).
3. Determining the drop probability as p_{drop}=1.00−p_{d}/\hat{p}ᵢₙ.
4. For every buffer request that arrives, dropping it from the system with probability p_{drop}.

The Open-loop Control Algorithm will correctly maintain the per-state stationary probabilities in the constrained region relative to the stationary probability of the first state of the QoS specification, the bottleneck state β. It does this using no feedback: only the transition ratios and the estimated request and service probabilities are needed. However, recall that the QoS specification is not a full specification: there must exist some unspecified states. Hence, in the initialization steps, it is impossible for the control software to calculate the transition ratio r_{β-1}, which is necessary to maintain π_{β} equal to s_{β}. The open-loop control stage is therefore unable to maintain the QoS-specified stationary probability for state β without outside assistance, which introduces errors into the stationary distribution as a whole. To correct these errors, a PID feedback stage may be employed to maintain state β's absolute probability at the correct, specified value by making changes to r_{β-1.}

According to one embodiment, the PID tier of the controller records the empirical distribution of the resource system, calculates the difference between this distribution and the QoS specification, and then modifies r_{β-1} the transition ratio for the bottleneck state, β) that the absolute value of state β's stationary probability is correct. A useful metaphor for understanding the control action of the PID tier is to think of the probability mass as flowing towards higher states when demand exceed recycles, with the PID controller acting as a valve for that mass to pass through state β and into the constrained states. Since not all of the mass will be allowed “through,” a large amount of probability mass will build up in the states immediately preceding β, hence its name as the bottleneck state.

FIG. 8 illustrates a controller with a Proportional/Integral/Derivative feedback stage. In this example, resource demands enter from the top left; the controller computes a drop probability that it uses to selectively ignore each demand. The two filters at the top of the diagram estimate instantaneous demand rate (the input filter 550) and the demand rate after modification by the control system (the service filter 560).

According to this example, the open-loop stage calculates the drop probability from the transition ratio table. The closed-loop stage (a PID controller in this example) generates an error value from the difference between the empirical distribution and the QoS specification, and uses that value to correct errors in the open-loop stage.

The open-loop controller calculates a request drop rate based upon the table of per-state transition ratios precalculated from the QoS distribution specification S(x), and the empirical history recorder saves a history of the actual distribution, E(x), as measured by the output filter (the empirical distribution vector). The difference between the specification and the history is an error vector, and the sum of the elements of this error vector is a scalar error, ε, that indicates the difference in probability mass between the specification and reality. According to one embodiment, this scalar error is used to drive a Proportional/Integral/Derivative controller 640, 650, and 660 that modifies the transition-table entry R_{β-1}, which determines probability of transitions into the bottleneck state, β.

According to the present example, the nonlinear transform block 630 at the heart of the controller is a Lyapunov-function like way to handle the strong saturation effects that arise in these networks.

With this background, the numerical example for the 10-state network buffer system will now be described. Assume that a system administrator has defined the following arbitrary QoS vector for the network buffer system of FIG. 2:
\vec{S}=|u,u,u,u,u,u,0.080,0.050,0.010,0.002|^{T}
where u indicates an undefined element. From this vector, the control software calculates the constrained and free probability masses in its initialization step:

$${π}_{c} = {\sum }_{i = 0}^{9} {s}_{i} = 0.142 \qquad ( 12 )$$

π_{f}=1.00−0.15=0.858 (13)

Ideally, πᵢ=sᵢ for every state i in \vec{S} for which sᵢ is defined. If πᵢ<sᵢ, the Chain spends less time in state i than allowed by the specification; this translates to an unwanted performance loss in actual systems. Conversely, if πᵢ>sᵢ, then the service specification has been exceeded. Hence in the initialization step, the control software can calculate the desired state-transition ratios, using Equation (6), to be:

$$\begin{matrix}{r}_{9} = \frac{{π}_{10}}{{π}_{9}} = \frac{0.002}{0.010} = 0.200 & ( 14 ) \\ {r}_{8} = \frac{{π}_{9}}{{π}_{8}} = \frac{0.010}{0.050} = 0.200 & ( 15 ) \\ {r}_{7} = \frac{{π}_{8}}{{π}_{7}} = \frac{0.050}{0.080} = 0.625 & ( 16 )\end{matrix}$$

In this example, state 7 is the bottleneck state (β=7). The open-loop stages requires r₆ in order to control the flow of probability mass into this state, but the QoS specification is undefined for state 6. This value is provided by the adaptive PID feedback section (which, for this example, is PI only).

If the values of \hat{p} and \hat{q} change slowly enough, it is possible to calculate r₆ (i.e., r_{β-1}) explicitly without the overhead of a closed-loop control stage. Such an embodiment of the invention would calculate the value of r_{β-1}, as follows, whenever needed (i.e., whenever p or q changes):
Calculate the value of π_{β-1}—the highest, unspecified state—as follows:

$$\begin{matrix}{π}_{f} = {π}_{β - 1} + {π}_{β - 2} + {π}_{β - 3} + … + {π}_{1} \\ {π}_{β - 1} + ( \frac{\hat{q}}{\hat{p}} ) {π}_{β - 1} + {( \frac{\hat{q}}{\hat{p}} )}^{2} {π}_{β - 1} + … + {( \frac{\hat{q}}{\hat{p}} )}^{n - β} {π}_{β - 1}\end{matrix}$$
hence

$${π}_{β - 1} = \frac{{π}_{f}}{{\sum }_{i = 0}^{n - β} {( \frac{\hat{q}}{\hat{p}} )}^{i}}$$
Calculate the value of r_{β-1} as follows:

$${r}_{β - 1} = \frac{{π}_{β}}{{π}_{β - 1}}$$

To complete the controller software for an actual system, the designer of the software would select a nonlinear transform as well as the gain constants for the P and I portions of the feedback stage (and the D portion, if present). These selections depend upon the desired control response (how fast the controller matches the actual response to the QoS specification, its stability around the ideal response, etc.) and will be different for every system.

In practice, to implement a software embodiment of the present invention, an engineer would write software to implement the open-loop and closed-loop stages of the controller, as well as the initialization steps. For the network buffer example, this software consists of a several small changes to the operating system kernel and a separate software package that allows users of the controller to enter their QoS specifications. Those users—the system administrators—do not need to possess expert knowledge of the system. Once initialized with a QoS specification, the control system would run on a continuous basis automatically protecting the resource pool and alerting the system administrator when a starvation condition is imminent. The overhead required by its use depends upon the exact resource pool being controlled, but in general would be small-so the controllers can be quite fast.

In conclusion, the present invention provides novel systems, methods and arrangements for controlling access to shared system resources. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method of controlling a resource management system, the method comprising:
modeling the resource management system with a Markov process;
empirically measuring a stationary distribution of resource states of the resource management system; and
modifying transition probabilities in the resource management system using feedback control to track a desired stationary distribution of the resource management system.

2. The method as recited in claim 1, wherein modeling the resource management system with a Markov process comprises estimating one or more resource request probabilities and one or more resource service probabilities, wherein one of the one or more resource request probabilities and one of the one or more of the resource service probability are used to estimate the transition probabilities in the resource management system.

3. The method as recited in claim 2, wherein estimating resource request probabilities comprises linear filtering.

4. The method as recited in claim 1, further comprising:
generating an error signal characterizing a difference between the empirically measured stationary distribution and the desired stationary distribution; and
applying a preconditioning transform to the error signal.

5. The method as recited in claim 4, wherein the preconditioning transform comprises applying a nonlinear transform to generate a modified error signal.

6. The method as recited in claim 1, wherein modifying transition probabilities comprises dropping one or more requests.

7. The method as recited in claim 1, wherein modifying transition probabilities comprises buffering requests.

8. The method as recited in claim 1, wherein the feedback control is determined by a proportional, integral, and derivative (PID) controller.

9. The method as recited in claim 8, wherein PID controller parameters are selected using analytical methods.

10. The method as recited in claim 8, wherein PID controller parameters are selected using experimental methods.

11. The method as recited in claim 8, wherein PID controller parameters are selected using the Ziegler-Nichols method.

12. The method as recited in claim 1, wherein the resource management system is a network subsystem.

13. The method as recited in claim 12, wherein the network subsystem is an OpenBSD networking subsystem.

14. The method as recited in claim 1, wherein the resource management system is a memory system.

15. The method as recited in claim 1, wherein the resource management system is a plurality of TCP/IP network routers.

16. The method as recited in claim 1, wherein the resource management system is a kernel table of an operating system.

17. The method as recited in claim 1, wherein the resource management system is a server software system.

18. The method as recited in claim 1, wherein the resource management system is a telephone switch system.

19. The method as recited in claim 1, wherein the resource management system is a transportation system.

20. The method as recited in claim 1, wherein the resource management system is a flight system.

21. A method of controlling access to system resources resulting in systematic service degradation, the method comprising:
developing a stochastic model of dynamic states of the system resources;
calculating a control ratio table by computing the ratio of input resource request to serviced resource request of the stationary probabilities of adjacent states in a Birth/Death Chain, wherein the control ratio table comprises ratios of admitted requests to serviced requests that must be maintained in order to satisfy a quality of service (QoS) specification;
receiving a resource request from one or more resource requestors;
utilizing the stochastic model to dynamically adapt to a system state;
controlling access of the resource requesters to the requested resources using feedback control to adjust probability distribution of the admission of the resource requests admitted to the system to cause an empirically measured distribution of the system to track a desired limit distribution.

22. A system for controlling access to one or more system resources through service degradation, the system comprising:
a memory having data representing a stochastic model of a dynamic state of the one or more system resources;
a resource manager configured to manage a plurality of resource requests granted access to the one or more system resources;
an input request filter configured to estimate an input request probability based on historical data, the input request probability representing a probability of receiving a resource request;
a service filter configured to estimate a service probability, the service probability representing a probability that a resource request will be serviced;
a distribution recorder configured to compute and record an empirical probability distribution characterizing a probability of a quantity of the one or more system resources being used;
a transition ratio table having data representing transition probabilities of changing from one state to another;
a control algorithm configured to utilize a difference between a desired limit distribution and the empirical probability distribution to produce a control signal; and
an admission controller configured to receive resource requests from one or more resource requesters and determine whether a received resource request should be granted access to the system resources, wherein the admission controller comprises a drop state calculator configured to use the estimate of the input request probability, the estimate of the service probability, and the control signal to generate a resource request denial probability which is used to determine whether the resource request should be granted access to the system resources.

23. The system of claim 22, wherein the memory has stored thereon computer executable instructions causing a computer to:
model the resource management system with a Markov process;
empirically measure a stationary distribution of the resource management system; and
modify the transition probabilities in the resource management system using feedback control to track a desired stationary distribution of the resource management system.

24. The system of claim 22 wherein the transition table is computed from a quality of service specification specifying a maximum allowed probability of a given resource state.

25. A computer-readable storage medium containing a set of instructions executable by a computer having a user interface, the set of instructions comprising:
(a) a first input routine operatively associated with said user interface, said first input routine enabling the computer to receive a desired limit probability distribution from said user interface;
(b) a second input routine operatively associated with said user interface, said second input routine enabling the computer to receive a desired set of controller parameters through said user interface;
(c) an analysis module empirically measuring a stationary distribution characteristic of a resource management system; and
(d) an admission controller modifying an admission policy of the resource management system by using feedback control to adjust probabilities of admittance and denial of resource requests from one or more resource requestors in order for said resource management system to track a desired stationary distribution of the resource management system.
